(19) United States
(12) Patent Application Publication
(10) Pub. No.: US 2008/0313150 A1
(43) Pub. Date: Dec. 18, 2008

(54) Centralized Network Data Search, Sharing and Management System

(76) Inventors: Christopher Penner, Madison, CT (US); Robert Phan, Branford, CT (US); William Ahern, San Francisco, CA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/955,804

(22) Filed: Dec. 13, 2007

Related U.S. Application Data
(60) Provisional application No. 60/869,727, filed on Dec. 13, 2006.

(51) Int. Cl. G06F 17/30; G06Q 30/00; G06F 15/16

(52) U.S. Cl. 707/3; 705/14; 707/E17.01; 707/E17.028

(57) ABSTRACT

The Personal Internet Multi-Media Channel Broadcast and Advertising System is designed to provide cell phone or other remote internet users with the ability to access stream media files from a personal computer to a cell phone, or other internet connected device, and is facilitated and enabled by a central server which may establish and route connections between the computers and cell phones. Channels or media content may be created on the personal computer and sent through the central server to be viewed by one or many cell phones, or other internet connected devices.

### CROSS REFERENCE TO RELATED APPLICATION(S)

This patent application claims benefit under 35 U.S.C. §119(e) of copending, U.S. Provisional Patent Application Ser. No. 60/869,727, filed Dec. 13, 2006, the disclosure of which is incorporated by reference herein in its entirety.

### BACKGROUND

(1) Field

The present disclosure relates generally to a personal internet multi-media channel broadcast system. Specifically, the disclosed subject matter relates to a system where a remote internet user has the ability to access streaming media files from a digital storage device to a remote internet enabled device.

(2) Description of Related Art

There are several methods of streaming media over the internet. A media stream can be in an on demand or live format. An on demand stream is stored on a server for a long period of time, and is available to be transmitted at a user's request. In contrast, a live stream is only available at a specific time.

Several protocols have been designed to support media streaming. A protocol is a specification for accessing media content. Real-Time Streaming Protocol (RTSP), for example, was designed to stream media over data networks. RTSP is an application-level protocol for control over the delivery of data with real-time properties and provides framework to enable controlled, on-demand delivery of real-time data. The sources of data can include both live data feeds and stored clips. In an RTSP system, a client can remotely control a streaming media server and access to files on a server. RTSP as commonly deployed, however, incurs limitations because client RTSP applications are not as common and are more difficult to incorporate into. A method for the real-time distribution of streaming data on a network is disclosed in U.S. Pat. No. 7,305,483 to Yao, et al. which is incorporated by reference in its entirety herein.

HTTP is used in many schemes to request and download media in a manner similar to RTSP. Adobe Flash, for example, uses HTTP in this manner. However, as a simpler and more generalized protocol, HTTP poses limitations and obstacles for efficiently requesting and controlling the download and playback of audio/video media. RTSP is derivative of HTTP.

Another class of protocols includes those widely used in peer-to-peer systems. In a peer-to-peer system, media is sent from one source having the desired media to a second source desirous of obtaining the media. There is no central server managing the network and no central router in a peer-to-peer system. There are several disadvantages to using a peer-to-peer network. Spam, illegal downloading, polluting attacks can all cause a network to perform very slowly or even break down.

One characteristic shared among all the above protocols is that they are not universal. For example, one class of internet enabled device may support only RTSP, such as most cellphones, while with another class it may be preferable to use HTTP. Similar issues arise with the type and format of content viewable on classes of devices. Thus, one problem is how to make content which is normally accessible and viewable on a subset of devices accessible and viewable on a larger subset of devices, as efficiently and convenient as possible, and in a manner amenable to incorporating future classes of devices into the system.

Another issue that arises when using the above protocols is firewalls. It is a common occurrence for a firewall to block the protocols and prevent the media from getting to the final destination, particularly if a request for media originates externally from the firewalled network. Preventing the initiation of data transmission from unknown third parties is often considered a feature of firewalls, but when not desired, it can be difficult to disable by lay people. Some current solutions include UPnP, which defines an interface whereby software can reconfigure a local firewall on behalf (and without the intervention) of a user. This is discussed in U.S. Pat. No. 7,290,132 to Aboba, et al, which is hereby incorporated by reference in its entirety. The UPnP technology cannot work if the firewall is not controllable by the user; for instance, if the firewall is installed and managed centrally by the ISP, as opposed to on a user's cable or DLS router. Another mechanism is commonly referred to as UDP Hole Punching. UDP Hole Punching and similar mechanisms require special purpose software applications both inside and outside of the firewall to cooperate. For example, two communicating users both share the proprietary software. Thus, large classes of lay people cannot readily publish media content and deploy a personal media server, because remote viewers cannot initiate and request transmission of media. Instead, they must upload and publish content on third party servers, often with concomitant storage space, content duration, and other constraints imposed on them by using these services (services above and beyond a simple data service provided by an ISP). There is no system designed to work with and around this limitation, but also to be capable of a configuration which need not add any extra complexity if this limitation does not exist in any particular instance; and to be capable of this transparently to the other components described herein.

### BRIEF SUMMARY

One aspect of the present disclosure is a system for centralizing data searching, sharing and management having a central server, the central server having a computer authentication module, a caching module, a routing mechanism and a device authentication module; a computer module, the computer module being in communication with the central server; an internet enabled device, where the internet enabled device is in communication with the central server; and an advertising module in communication with the central server, the computer module, and the internet enabled device.

Another aspect of the present disclosure is a system for centralizing data searching, sharing and management having a central server having a computer authentication module, a caching module, a routing mechanism and a device authentication module. The system also having a computer module, the computer module being in communication with the central server using a RTSP technology, the computer module having a desktop application effective to enable a remote internet enabled device to connect to the central server and stream media from the computer module; an internet enabled device, where the internet enabled device is in communication with the central server; and an advertising module in communication with the central server, the computer module and the internet enabled device.

Another aspect of the present disclosure is a method of sharing data comprising installing a desktop application on a computer, where access is granted to a central server having a plurality of subscribers. Next, selecting data to be shared with the subscribers. Then accessing the central server and browsing profiles of the subscribers, selecting data from the profiles of the subscribers; and streaming the data to an internet enabled device.

### BRIEF DESCRIPTION OF THE DRAWINGS

For the purpose of illustrating the subject matter disclosed the drawings show a form of the disclosure that is presently preferred. However, it should be understood that the present disclosure is not limited to the precise arrangements and instrumentalities shown in the drawings, wherein:

FIG. 1 is a schematic of a system according to the present disclosure;

FIG. 2 is a schematic of a computer module according to the disclosed subject matter; and

FIG. 3 is a screen shot of the disclosed subject matter; and

FIG. 4 is a flow chart of a method according to one embodiment of the disclosed subject matter.

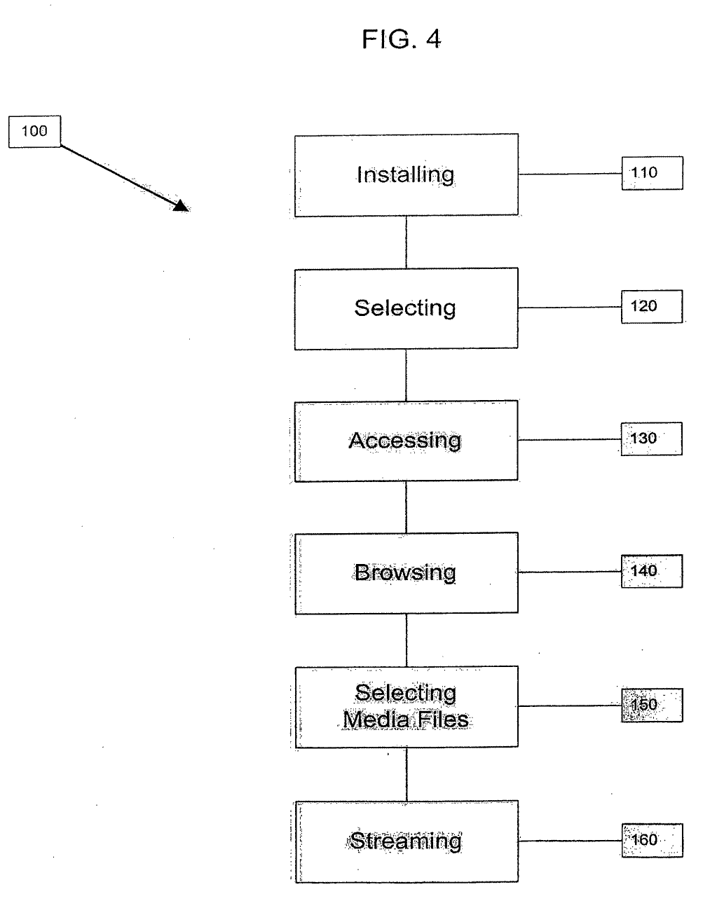

### DETAILED DESCRIPTION

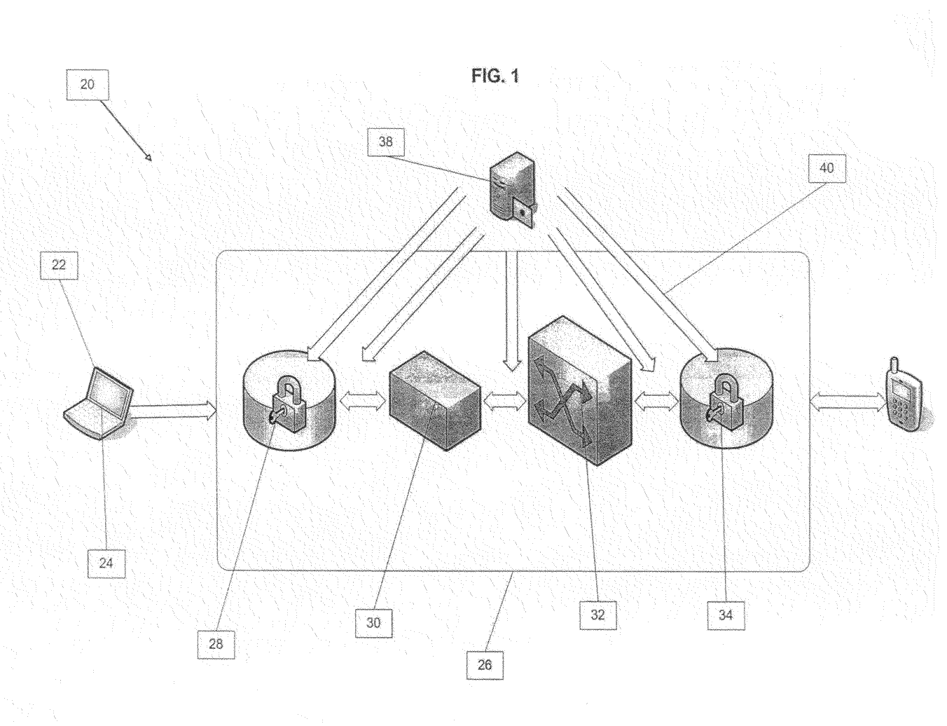

Referring now to the drawings in which like reference numerals indicate like parts, and in particular, to FIG. 1, one aspect of the disclosed subject matter is a system 20 for centralizing network data searching, sharing and management. System 20 includes a computer module 22, having a desktop application 24; a central server 26 having a computer authentication module 28, a caching module 30, a routing mechanism 32, and a device authentication module 34; an internet enabled device 36, and an advertising module 38.

Computer module 22 can be a desktop computer, a laptop computer, or any other computer device known in the art. Computer module 22 can be loaded with a desktop application 24, which typically is a program designed to allow remote internet enabled device 36 to connect to a central server, such as central server 26, and stream data such as media in an on-demand format from computer module 22.

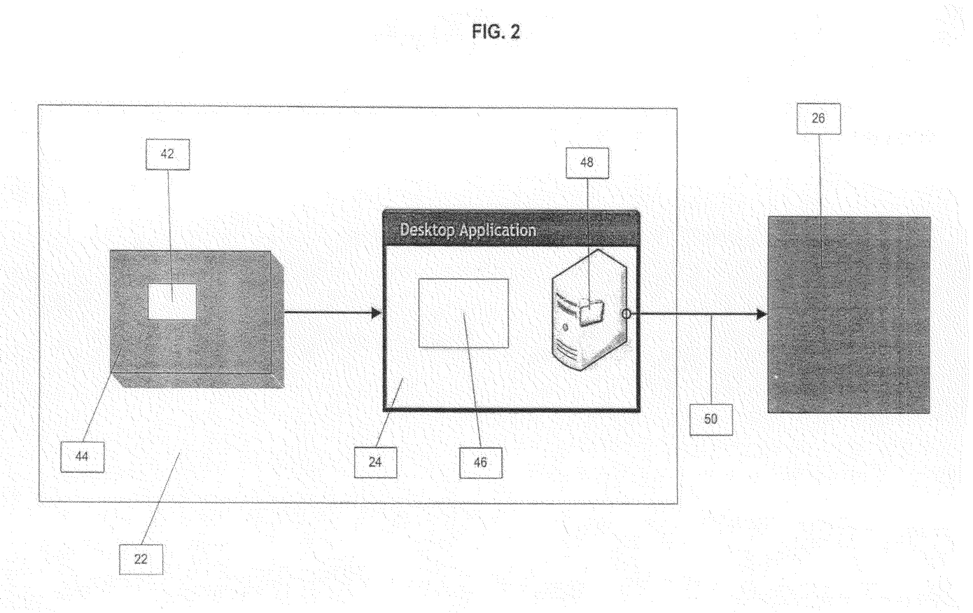

Turning now to FIG. 2, a schematic of computer module 22 is shown. When desktop application 24 is loaded onto computer module 22, data, such as files 42 from the hard drive 44 of the computer module that are desired to be shared, can be loaded onto the desktop application. Files 42 can be copied or transferred from hard drive 44 of computer module 22 to desktop application 24. Files 42 in hard drive 44 can be of any type such as music files in MP3, WAV or AAC format; video files in MPEG, AVI, DivX, or MOV format; pictures in JPEG, PNG or GIF; or any other type of file in any form. Such a form may incorporate media content by reference (such as by a URL) so that the file format consists of this reference or references to media content external to the file. The PLS and MOV formats include this function as part of their specification.

Once files 42 are transferred onto desktop application 24, the files may be immediately transcoded, or converted to streamable files by a transcoding mechanism 46. This process may be delayed, so that the transcoding process does not need to occur or complete prior to the first access request, and may occur for each or any subsequent request. Transcoding mechanism 46 can be located in desktop application 24, central server 26, or in both. Files 42 are initially converted into a common format, such as 3GP. Files 42 are then in a format that can then be streamed to central server 26. Files 42 may then be streamed to, or stored on, central server 26 where the files may be made available for viewing on internet enabled device 36.

Transcoding mechanism 46 involves decoding and encoding data, such as files 42, such that multiple files can be decoded and re-encoded into a single stream. By this process data can be differentiated into channels 40 such as browseable channels and non-browseable channels. Non-browseable channels are viewed as an aggregation of one or more input media files, streamed as a single input media file (analogous to a television or radio “channel” whereby multiple segments and shows are broadcast within a single channel, undifferentiated and seamless within the context of the channel.) The typical mechanism used by those skilled in the art is for the client viewer application to play such data in a series, whereby multiple files are requested and accessed, and then played in serial. The data arrives at internet enabled device 36 differentiated and subsequently composed on the device; the internet enabled device necessarily must be cognizant of the differentiated character of the data.

Browseable and non-browseable channels 40 are created and composed by a user aggregating data into the channels. In one embodiment of the disclosure, files 42 can be dragged or dropped from a program such as Windows Explorer (MS Windows), Finder (Apple), or from a WWW browser (Internet Explorer, Firefox), or similar applications or by similar modes. Files 42 can be incorporated while creating a named channel, e.g. through a file dialog box. Channels 40 can be created locally or from a remote location. For example, a file can be added to a channel using a remote internet enabled device. Channels 40 can then be organized in a manner similar to the way a lay computer user organizes files and directories/folders on their computer, such as by artist, album, date, or the like suing channel folders 48.

In one embodiment of the present disclosure, channel 40 can contain zero or more files, as well as zero or more channels. Channel 40 can be contained within one or more channels. This hierarchical organization begets one method for viewers to discover and select files aggregated by any particular user, and by multiple users (by joining or merging these hierarchies). The hierarchy of channels are stored in a database and in a manner not necessarily restricted to representing hierarchies. Thus, desktop application 24 may employ the file system of computer module 22. For example, storing files as files, channels as directories/folders, and marking the browseability attribute using hidden a file, or by use of a relational database, or any other storage mechanism capable of recording these relationships. Likewise, such mechanisms might simultaneously be used desktop application to record and index keyword and other identifying attributes for natural language or machine language searching. Such methods are well known by those skilled in the art.

The transcoding process may repeat in reverse on central server 26 so that the common format, such as 3GP, is transcoded to the common format required or requested by internet enabled device 36. In one embodiment of the present disclosure, FFmpeg can be used to provide the necessary decoding and encoding mechanism for a large set of the multitude of possible input and output formats. Any chosen mechanism must provide, such as FFmpeg does, the ability to modify the content between the decoding and encoding phases so as to implement additional functions such as the non-browseable feature or the advertisement concept discussed below

The common format 3GP, represents a large common denominator of media types. An uncompressed format would use more network bandwidth than necessary when transmitted between desktop application 24 and central server 26. The 3GP specification effectuates such a compression property, as well as providing easy analysis and manipulation of the structure of the content so as to promote streaming and transcoding. 3GP is not required, however, an example of an insufficient format would be one which did not allow the files 42 to be decoded or encoded without having received the content in full. Such a limitation would preclude delayed and on-demand transcoding, as well as preclude the ability to reference remote files without retrieving them in their entirety and in advance of a request by the viewing internet enabled device. Another property of 3GP is more comprehensive and portable support in third party software libraries.

Non-browsable channels are created by installing desktop application 24, as described above, on computer module 22 and selecting files 42 to be played on a channel 40. Files 42 may be transcoded by desktop application 24 or central server 26. The selected files 42, after transcoding, may be played by internet enabled device 36 from start to finish, as an indivisible collection, and may be repeated as often as desired. A user may choose to make this type of channel viewable by any user accessing the central server with a cell phone application.

Files 42 that are being stored in channel folders 48 can then be streamed to central server 26 by data streaming mechanism 50. Data streaming mechanism 50 can be used to stream files 42 to or from desktop application 24 to central server 26.

Turning now back to FIG. 1, computer module 22 connects to central server 26 to register its status and to record its network location. Authentication module 28 prevents erroneous or malicious recording of network locations, but the details of implementation typically depend on the VPN implementation. In one embodiment of the disclosed subject matter, authentication draws heavily from PKIX, including use of X.509 certificates which is known to those skilled in the art. If computer module 22 is located behind a firewall or is unsure whether there are network obstructions which preclude externally initiated network access (by the central server or internet enabled devices) a Virtual Private Network (VPN) connection can be established. If a VPN connection is established the network location is recorded by reference to the VPN connection to central server 26, or the location is recorded as its own internet network TCP/IP address.

When desktop application 24 or computer module 26 initiates data streaming to central server 26, the data streaming mechanism 50 may use TCP/IP. However, when central server 26 initiates data streaming connections, and computer module 22 has established a VPN connection, then the data streaming mechanism 50 will employ this VPN, otherwise the data streaming mechanism will likewise use TCP/IP. The VPN allows network obstructions such as firewalls, which normally might reject incoming connections to computer module 22 not to discern data streaming mechanisms 50 which are contained within the VPN connection. The VPN itself may use TCP/IP, or, for example, may use UDP/IP. Data streaming mechanism 50 thus utilizes IP+TCP, or IP+TCP+VPN, or IP+UDP+VPN, and provides an unobstructed mechanism for desktop application 24 and computer module 22 to communicate with central server 26 and internet enabled devices 36.

Data streaming mechanism 50 uses additional typically protocols such as Real-time Streaming Protocol (RTSP) or Hypertext Transfer Protocol (HTTP). Both RTSP and HTTP protocol technology are well known in the art as specifications used for accessing media content. Both protocols employ URLs to identify the media resource to be accessed, as well as specify mechanisms for declaring the formats presentable or otherwise usable by the accessing application. Neither RTSP or HTTP, by design, requires the content to be fully transmitted before the application can present the data to the viewer, or otherwise processes the data, and generally transmission of data occurs in the logical order of beginning to end. This latter property can be contrasted with, for instance, a peer-to-peer protocol, which might begin transmitting the end of a file, then the middle, and finally the beginning. The invention is not limited to the use of RTSP or HTTP as part of the data streaming mechanism, but these three characteristics, URLs, format signaling, and stream-orientation, are required. The URL allows central server 26 to perform its routing role, the format signaling allows the central server to perform transcoding, and stream-orientation enables the implementation of the URL.

Central server 26 also contains a caching mechanism 30 which temporarily stores streamed data. This is one instance where desktop application 24 may initiate data streaming. This allows for faster and more numerous access by other internet enabled devices 36. The data stored in the desktop application can than be accessed by another subscriber or by any internet enabled device 36 without saturating the network bandwidth of computer module 22, or requiring the computer module to be accessible by data streaming mechanism 50 simultaneous to the time of request.

Central server 26 also contains routing mechanism 32. Routing mechanism 32 ensures that each request for data made by internet enabled device 36 is directed to the proper computer module 22 and desktop application 24. There can be a large number of subscribers to the system and routing mechanism 32 ensures accuracy and efficiency. Routing mechanism 32 allows central server 26 to be comprised of one or more separate pieces of computer hardware and/or software.

When internet enabled device 36 requests access to central server 26, typically using HTTP or RTSP, device authentication module 34 can either allow or deny access to the internet enabled device. This is an additional security measure to ensure that authenticated users can be securely identified, and that computer module 22 can securely control access to media file. If access is granted to internet enabled device 36, central server 26 connects to computer module 22 using data streaming mechanism 50 and a protocol such as RTSP or HTTP.

Device authentication module 34 uses the authentication token embedded in the URL provided in HTTP or RTSP access by internet enabled device 36. This authentication token can contain the username (or other identifier) of an authenticated user, as well specify expiration of the token. Authentication token uses concepts well known to those skilled in the art; in particular, it uses cryptographic and other design elements similar to the widely used mechanism, Kerberos. Specifically, internet enabled device 36 communicates with device authentication module 34 independently from communication with central server 26; likewise the central server communicated with the device authentication module independently from the internet enabled device. Thus, the specification for internet enabled device as to communications with central server is limited only to the three requirements enumerated above with regards to HTTP, RTSP or similar protocols, and the insertion of any authentication token into the URL. By design the mechanism by which internet enabled device 36 communicates with device authentication module 34 can be any capable method resulting in the internet enabled device acquiring an authentication token for embedding into URLs, or otherwise acquiring URLs with valid authentication tokens, generated by device authentication module.

Internet enabled device 36 can be a cell phone, a handheld device or any other internet enabled device. Internet enabled device 36 can be equipped with a variety of different features such as a log-on screen, having a user's preferred channels displayed. Other features can include search tools, browsing tools, invitations, preferences and publish. A search tools function could enable a user to search desired content. A browsing tool can be used to browse channels by different categories such as genre, publisher, and content. By having an invitation option, a user can invite other users to view their channels or to try the system by using SMS or other messaging technology. The preferences feature allows a user to adjust their personal preferences on the internet enabled device 36, the desktop application 24 or the central server 26. The publish feature enables a user to publish any videos or other media from the internet enabled device to computer module 22, using substantially the same mechanism for viewing.

In addition to computer module 22, advertising module 38 is another mechanism for inserting data into the stream. Advertising module 38 can insert any type of data through channels 40 into the stream at any point. The inserted data may take the form of advertisements or other information which can be inserted into an existing channel at any point within the stream between the desktop application, central server, or internet enabled device, such that similar to non-browseable channels, the advertisement is not readily differentiated by the accessing internet enabled device. That is, similar to advertisements in broadcast television, the accessing device uses timeshifting or other contrivances to skip or exclude advertisements, since the content as delivered is logically indivisible. In contrast, as described above, the typical mechanism of internet media advertisement today, where advertisements are incorporated by reference in the content, and the viewing application must compose and present referenced media serially. Since the user ostensibly controls the internet enabled device (either by modifying the software or hardware), he can circumvent any composition function to skip advertisements or other effects.

The components of the present disclosure may reside on one or more pieces of computer hardware. The components may be consolidated into a single component, wherein all parts of the invention reside on a single computer module, or exist as several distributed components. The system may perform as a narrowcasting system, where a single internet enabled device may access data from a single desktop application through the central server, or as a broadcasting system, where multiple internet enabled devices access data from a single desktop application. The disclosure may include many desktop applications providing data to many internet enabled devices, however all data will pass through the central server where it is routed to the proper internet enabled device.

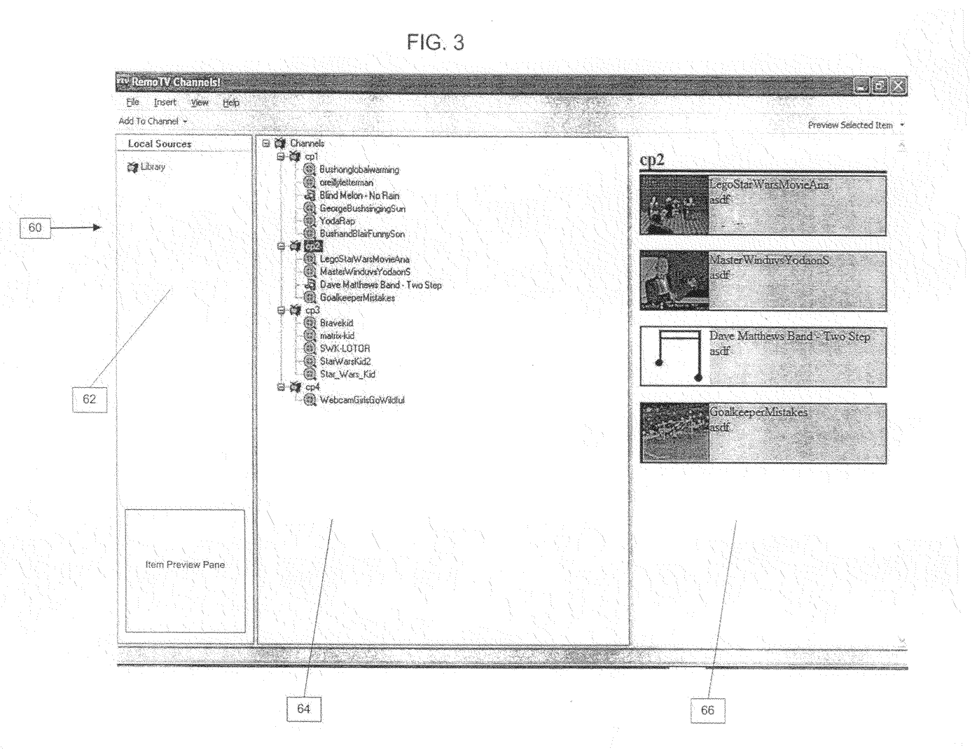

Referring now to FIG. 3, a screen shot 60 of the desktop application 24 is shown. In one embodiment of the disclosed subject matter, the screen can display the available libraries 62 of desktop application 24. In addition, a channel creation pane 64 can also be seen. Channel creation pane 64 is where channels 40 may be created and organized and data may be inserted into or moved within the channels. Channel creation pane 64 can include channels 40 that have been created and data within the channel. Item preview pane 66 is where data may be previewed. The data can be viewed or listened to within desktop application 24 in the same manner they would appear to the internet enabled device 36.

Referring now to FIG. 3, a flow chart of a method 100 according to the present subject matter is shown. At 110, a desktop application is installed on a computer. The desktop application creates a subscription to the program whereby access is granted to a central server having a plurality of subscribers in a network. The desktop application is designed to enable the user to share and obtain data by streaming. At 120, data is selected from the computer's hard drive and transferred or copied into the desktop application and then entered into either browsable or non-browsable channels. The selected data entered into browsable channels will become accessible to all subscribers in the network.

Once the data desired to be shared is selected, the user can transcode the data into a streamable format. The transcoded data can be stored in one or more channel folders, which may consist a group or list of any type of media files and may be browsable or non-browsable. The channel folders can be named and organized in any manner the subscriber desires. The subscriber can then create a profile to be viewed by other subscribers on the network. A browsable channel may allow a subscriber using the internet enabled device to access the channel through the central server, and select the data or media files they wish to access. A non-browsable channel may allow a subscriber using the internet enabled device to access a compilation or play list of media files created by the channel owner. Once a channel is created by the desktop application, all data is streamed to the central server where it may be cached before it may be streamed from the central server to the internet enabled device. The data may be streamed using any real time streaming protocol such as RTSP or HTTP (limited as describe above) employed by any internet enabled device, such as Microsoft Media Player or Adobe Flash on a personal computer or a movie player within a cellphone. The former applications, for instance, typically use HTTP, while the latter RTSP. Data sent to the central server may be converted, by either the desktop application or the central server, to a format required by internet enabled device.

At 130, the user can request entry onto the central server. If the user requesting access is an authenticated user, access will be granted to those channels restricted to a class of such authenticated users. At 140, the user can browse other user's profiles to determine if there are any media files they are desirous of hearing or seeing.

At 150, the user selects a media file they are desirous of hearing or seeing. At 160, the selected data is streamed to an internet enabled device. The internet enabled device can be a cellular phone, a computer or any other device. The selected data is streamed to the internet enabled device using RTSP or HTTP technology and is played in an on-demand format. There is no need to download the data, or store it on the device. This allows for fast, efficient access that does not clog a computer's storage space.

In one embodiment of the present disclosure, a user or central server administrator may select to have additional data inserted into either browsable or non-browsable channels. This data may be in the form of advertisements. If a user chooses to insert advertisements into their channels, the data may be inserted by either the desktop application, the internet enabled device, or the central server. One advantage of inserting advertisements is generating revenue which may be shared by the user and the administrator of the central server. The amount of additional data which is inserted into the channels may be controlled by the desktop application user or the central server operator.

In another embodiment of the present disclosure, the transcoding may also take place on the central server rather than the desktop application. The selected data may be accessed from the central server by the internet enabled device. Data selected to be accessed in this manner would have to be entered into a browsable channel. The internet enabled device subscriber may view the available data and may select to play any of the data. Access to these data may be controlled by the channel creator or a third party.

In yet another embodiment, only the internet enabled device is used to view browsable or non-browsable channels without using the desktop application. This type of use may begin with downloading and installing an internet enabled device application rather than a desktop application. Internet enabled device users may view all available channels available by accessing the central server. These channels may be categorized and searched according to a user's preferences or by the central server operator.

The data provided by the desktop applications may be searched so that users of the internet enabled devices may easily find the data they desire. In addition to the data that a desktop application user broadcasts to the central server, additional data may be inserted into the broadcast either by the desktop application or central server. The additional data may contain advertisements or other information.

The internet enabled device application may access data sent from the central server. Data may be streamed from the central server in any format which is readable by the internet enabled device. Additionally, the internet enabled device may have additional features such as the ability to invite a new user to sign up for service, download, install, and use the internet enabled device via SMS, Instant Messaging, or any other messaging system.

The central server may manage all connections between the internet enabled device and the desktop application and as such may grant or limit access to data or channels. Access to a channel may be controlled by either the central server operator or the desktop application operator. Data received by the desktop application may be converted to a format which is accessible by the internet enabled device.

In another embodiment of the present disclosure, the inclusion or insertion of additional data into the stream may be performed either by the desktop application, the central server application or the internet enabled device. When inserted by the desktop application or internet enabled device the data may be downloaded and updated on a regular basis from the central server. The data is inserted periodically as specified by the desktop application or central server or preferences for the channel being viewed. When inserted by the desktop application the data may be part of the media file or play list that the user transcodes or create. When inserted by the internet enabled device, the data may already reside on the internet enabled device and may be played by the internet enabled device during pauses in the media content. When inserted by the central server the data may be inserted into a media stream at any time or interval. Much of the data inserted into media streams may be advertisements. These advertisements may be inserted as often as is specified by either the channel creator or the central server administrator. Information such as how often an advertisement is played or viewed, by whom, or any action performed by the viewer, may be collected.

Although the disclosure has been described and illustrated with respect to exemplary embodiments thereof, it should be understood by those skilled in the art that the foregoing and various other changes, omissions and additions may be made therein and thereto, without parting from the spirit and scope of the present disclosure. Accordingly, other embodiments are within the scope of the following claims.

What is claimed is:

1. A system for centralizing data searching, sharing and management comprising:
a central server, said central server having a computer authentication module, a caching module, a routing mechanism and a device authentication module;
a computer module, said computer module being in communication with said central server;
an internet enabled device, wherein said internet enabled device is in communication with said central server; and
an advertising module in communication with said central server, said computer module, and said internet enabled device.

2. A system for centralizing data searching, sharing and management as in claim 1, wherein said computer module connects to said central server using a protocol selected from the group consisting of RSTP technology and HTTP technology.

3. A system for centralizing data searching, sharing and management as in claim 2, wherein said computer module further comprises a desktop application effective to enable a remote internet enabled device to connect to said central server and stream media from said computer module.

4. A system for centralizing data searching, sharing and management as in claim 3, wherein said desktop application further comprises a transcoding mechanism effective for converting files into a streamable format.

5. A system for centralizing data searching, sharing and management as in claim 4, wherein said central server further a transcoding mechanism, wherein said transcoding mechanism is effective for converting a file into a streamable format used by said internet enabled device.

6. A system for centralizing data searching, sharing and management as in claim 5, wherein said desktop application further comprises channel folders, said channel folders effective for managing said files.

7. A system for centralizing data searching, sharing and management as in claim 6, wherein said computer module transfers said files to said central server by a data streaming mechanism.

8. A system for centralizing data searching, sharing and management as in claim 7, wherein said routing mechanism streams said files to an internet enabled device using channels.

9. A system for centralizing data searching, sharing and management as in claim 8, wherein said channels are in communication with said computer module, said internet enabled device, said central server, and said advertising mechanism.

10. A system for centralizing data searching, sharing and management as in claim 8, wherein said advertising module is effective for streaming said files into said channels.

11. A system for centralizing data searching, sharing and management comprising:
a central server, said central server having a computer authentication module, a caching module, a routing mechanism and a device authentication module;
a computer module, said computer module being in communication with said central server using a RSTP technology, said computer module having a desktop application effective to enable a remote internet enabled device to connect to said central server and stream media from said computer module;
an internet enabled device, wherein said internet enabled device is in communication with said central server; and
an advertising module in communication with said central server, said computer module and said internet enabled device.

12. A system for centralizing data searching, sharing and management as in claim 11, wherein said desktop application further comprises a transcoding mechanism effective for converting said media into a streamable format.

13. A method of sharing data comprising:
installing a desktop application on a computer, whereby access is granted to a central server having a plurality of subscribers;
selecting data to be shared with said plurality of subscribers;
accessing said central server;
browsing profiles of said plurality of subscribers;
selecting data from said profiles of said plurality of subscribers; and
streaming said data to an internet enabled device.

14. The method of sharing data according to claim 13, wherein selecting data to be shared with said plurality of subscribers further comprises transcoding said data to a streamable format.

15. The method of sharing data according to claim 14, wherein said data is stored in channel folders located in said desktop application.

16. The method of sharing data according to claim 15, wherein said channel folders are categorized.

17. The method of sharing data according to claim 16, wherein accessing said central server further comprises authenticating said subscriber's identity.

18. The method of sharing data according to claim 17, wherein said central server routes said data to said internet enabled device.

19. The method of sharing data according to claim 18, wherein said data is played on demand.
